(19) United States
(12) Patent Application Publication
(10) Pub. No.: US 2025/0125437 A1
(43) Pub. Date: Apr. 17, 2025

(54) BATTERY MODULE

(71) Applicant: INZICONTROLS CO., LTD., Siheung-si (KR)

(72) Inventors: Jung Min KIM, Siheung-si (KR); Soo Gil Kim, Siheung-si (KR); Hyoung Min Choi, Siheung-si (KR); Seung Yong Yoo, Siheung-si (KR)

(73) Assignee: INZICONTROLS CO., LTD., Siheung-si (KR)

(21) Appl. No.: 18/989,519

(22) Filed: Dec. 20, 2024

Related U.S. Application Data
(63) Continuation of application No. PCT/KR2023/011008, filed on Jul. 28, 2023.

(30) Foreign Application Priority Data
Jul. 29, 2022 (KR) 10-2022-0094444

(51) Int. Cl. H01M 10/6551; H01M 10/659; H01M 50/166; H01M 50/507

(52) U.S. Cl. CPC H01M 10/6551; H01M 10/659; H01M 50/166; H01M 50/507; H01M 2220/20

(57) ABSTRACT

A battery module according to an embodiment of the present invention may include: a battery cell having formed thereon cell tabs; a heat sink arranged on one side of the battery cell to discharge heat generated from the battery cell to the outside; bus bars connected with the cell tabs; a bus bar frame which supports the bus bars; a cooling plate arranged apart from the bus bar frame and connected to the heat sink to enable heat transfer; and a phase change member which is arranged between the cooling plate and the bus bars to transfer, to the cooling plate, heat generated at the connection sites between the bus bars and the cell tabs and which includes a phase change material that changes phase by absorbing the heat generated at the connection sites between the bus bars and the cell tabs.

### CROSS-REFERENCE TO RELATED APPLICATIONS

This application is a Continuation of PCT International Application No. PCT/KR2023/011008 filed on Jul. 28, 2023, which claims priority under 35 U.S.C. § 119(a) to Korean Patent Application No. 10-2022-0094444 filed on Jul. 29, 2022. The above applications are hereby expressly incorporated by reference, in their entirety, into the present application.

### TECHNICAL FIELD

The present invention relates to a battery module, and more particularly, to a battery module that may further improve cooling performance by applying a phase change material to the battery module and may effectively remove heat generated from the battery module by applying the phase change material at various locations of the battery module.

### RELATED ART

In general, a battery is widely used in an electronic device that may not be connected by wire, such as a portable electronic device, a mobile communication terminal, and an electric vehicle. Therefore, research and development of the battery is actively conducted as the battery market expands, but an accident in which the battery catches fire or explodes still frequently occurs.

Battery fire or explosion as described above occurs due to various reasons, such as damage by impact, design error, short circuit, and harsh use environment, and it is still difficult to completely prevent the battery fire or explosion.

Meanwhile, the distribution of electric vehicles is rapidly expanding in recent years. A high-capacity battery pack is used in a typical electric vehicle. In the case of the battery pack of the electric vehicle as described above, it is important to increase the performance and capacity, but it is also important to prevent casualty and property damage that may be caused by fire and explosion. To this end, in the recent times, research and development have been actively conducted to develop a battery back with high capacity, high efficiency, and high safety.

In particular, the purpose is to increase charging efficiency and to improve fuel efficiency by delaying temperature rise that occurs in a battery cell of the battery pack under rapid charging and harsh driving conditions of the electric vehicle. Further, technology for reducing the risk of fire and explosion of the battery module due to abnormality in the battery cell caused by the temperature rise is continuously being researched and developed. Currently, attempts have been made to improve the cooling performance of the battery module using a phase change material (PCM) that absorbs more heat during a phase change process.

However, the existing structure of applying the phase change material to the battery module refers to the structure of simply providing the phase change material around the battery cell and needs to consider a limited layout and weight energy density and accordingly, has a limitation in more intensively cooling a temperature increasing area of the battery cell. For example, as for an area in which most heat generated in the battery module, a connecting area between a cell tab and a bus bar of the battery cell is representative. However, the existing structure of applying the phase change material is not suitable for the structure of intensively cooling a heat generation area, such as the connecting area between the cell tab and the bus bar.

Accordingly, there is an increasing need to further improve the cooling performance of the battery module by enhancing the structure of applying the phase change material of the battery module.

### DETAILED DESCRIPTION

### Technical Subject

Example embodiments of the present invention provide a battery module that may further stably improve the cooling performance of a battery cell by enhancing the structure of applying a phase change material to the battery module.

Also, example embodiments of the present invention provide a battery module that may selectively cool various areas in which heat is generated in the battery module using a phase change material and may stably install the phase change material in various areas of the battery module.

### Technical Solution

According to an example embodiment of the present invention, there is provided a battery module including a battery cell formed with a cell tab; a heat sink provided on one side of the battery cell to discharge heat generated from the battery cell to the outside; a bus bar configured to connect to the cell tab; a bus bar frame configured to support the bus bar; a cooling plate provided separate from the bus bar frame, and connected to the heat sink to enable heat transfer; and a phase change member provided between the cooling plate and the bus bar, and including a phase change material that changes phase by absorbing heat generated in a connecting area between the bus bar and the cell tab.

Desirably, the battery module according to an example embodiment of the present invention may further include a module housing provided to surround the outer surface of the battery cell.

The cooling plate may be provided inside the module housing to be seated on the inner surface of the module housing. A portion of the cooling plate may extend long toward the heat sink and may be in contact with the heat sink to enable heat transfer.

Desirably, the phase change member may absorb heat generated in a connecting area between the bus bar and the cell tab and may temporarily store the same through phase change of the phase change material.

Desirably, a frame sidewall portion may be provided to the bus bar frame to protrude in a shape that surrounds the edge of the bus bar. The phase change member may be formed in a shape corresponding to the bus bar and provided in a state in which the phase change member is inserted into the inside of the frame sidewall portion.

The frame sidewall portion may be formed to further protrude than a thickness of the phase change member to closely adhere to the surface of the cooling plate. Here, the phase change member may be stored inside a phase change space portion formed by the frame sidewall portion, the bus bar, and the cooling plate.

According to another example embodiment of the present invention, there is provided a battery module including a battery cell formed with a cell tab on at least one of the front surface and the rear surface; a heat sink provided on one side of the battery cell to discharge heat generated from the battery cell to the outside; a module housing provided to surround at least a portion of the outer surface of the battery cell; a bus bar configured to connect to the cell tab; a bus bar frame provided between the module housing and the cell tab, and configured to support the bus bar; a cooling plate provided between the bus bar frame and the module housing, and connected to the heat sink to enable heat transfer; and a first phase change member provided between the cooling plate and the bus bar to transfer the heat generated in the connecting area between the bus bar and the cell tab to the cooling plate, and including a phase change material that changes phase by absorbing the heat generated in the connecting area between the bus bar and the cell tab.

Desirably, a lower portion of the cooling plate may extend long toward the heat sink and may contact the heat sink to enable heat transfer. Also, the first phase change member may absorb heat generated in the connecting area between the bus bar and the cell tab and may temporarily store the same through phase change of the first phase change material.

Desirably, the first phase change member may further include a thermal interface material added to the phase change material for the purpose of improving heat transfer performance.

Desirably, the first phase change member may further include a capsule member of an elastic material provided to accommodate the phase change material and the thermal interface material in a desired shape.

Desirably, a frame sidewall portion may be provided to the bus bar frame to protrude in a shape that surrounds the edge of the bus bar. The first phase change member may be formed in a shape corresponding to the bus bar and provided in a state in which the first phase change member is inserted into the inside of the frame sidewall portion.

Here, the bus bar may be provided in a plural form to the bus bar frame. The frame sidewall portion and the first phase change member may be provided in a plural form in a shape that corresponds to each of the bus bars.

The frame sidewall portion may be formed to further protrude than a thickness of the first phase change member to closely adhere to the surface of the cooling plate. The first phase change member may be stored inside a phase change space portion formed by the frame sidewall portion, the bus bar, and the cooling plate.

Desirably, the module housing may include a first housing cover provided on each of the front surface and the rear surface of the battery cell; and a second housing cover provided to cover the top surface, the left side surface, and the right side surface of the battery cell and of which lower end is connected to the heat sink to enable heat transfer.

Desirably, the battery module according to another example embodiment of the present invention may further include a second phase change member provided between a top surface portion of the second housing cover and the battery cell to transfer heat generated from the battery cell to the second housing cover and that changes phase by absorbing the heat generated from the battery cell.

Here, a phase change insertion groove into which the second phase change member inserts may be formed on the top surface portion of the second housing cover. The heat of the second phase change member may be transferred from the top surface portion of the second housing cover to the heat sink through both side portions.

Desirably, a frame sidewall portion may be provided to the bus bar frame to protrude in a shape that surrounds the edge of the bus bar. The first phase change member may be formed in a shape corresponding to the bus bar, and provided in a state in which the first phase change member is inserted into the inside of the frame sidewall portion. The first housing cover may be fixably fastened to the second housing cover at a location of closely adhering the cooling plate to the first phase change member.

A groove-shaped plate seating portion on which the cooling plate is seated may be provided on the inner surface of the first housing cover.

Desirably, the battery cell may be formed in a structure in which a plurality of unit cells are repeatedly arranged, and the cell tab may be provided at each of the front and the rear of the unit cell.

Desirably, the battery module according to another example embodiment of the present invention may further include a third phase change member provided between the unit cells to deliver heat generated from the unit cells to the heat sink, and including a phase change material that changes phase by absorbing the heat generated from the unit cells.

Here, the third phase change member may be provided in a structure in which the phase change material is mixed with a cushioning pad that serves as a buffer in response to expansion of the unit cells.

Alternatively, a cushioning pad that serves as a buffer in response to expansion of the unit cells may be additionally provided between the unit cells, separate from the third phase change member. Here, the third phase change member and the cushioning pad may be formed in a shape corresponding to the unit cell. At least one third phase change member and at least one cushioning pad may be provided between the unit cells.

According to still another example embodiment of the present invention, there is provided a battery module including a battery cell including a cell tab on at least one of the front surface and the rear surface; a heat sink provided on bottom side of the battery cell and configured to discharge heat generated from the battery cell to the outside; a module housing provided to surround at least a portion of the top surface and the side surface of the battery cell; a bus bar provided between the module housing and the cell tab, and configured to connect to the cell tab; a bus bar frame configured to support the bus bar; a cooling plate provided between the bus bar frame and the module housing, and configured to transfer heat to the heat sink; a first phase change member provided between the cooling plate and the bus bar; a second phase change member provided between the battery cell and a module housing; and the battery cell including a plurality of unit cells repeatedly arranged, and a third phase change member provided between the unit cells.

### Effect

A battery module according to an example embodiment of the present invention may more stably improve the cooling performance of the battery module by applying first to third phase change members each including a phase change material to a heat generation area of the battery module and, particularly, may significantly increase absorption and storage of heat generated from the battery module through a phase change effect on the phase change material of the first to third phase change members, and accordingly may prevent an abnormal temperature rise of the battery module by the first to third phase change members regardless of an instantaneous significant increase in the heat generated from the battery module.

Also, a battery module according to an example embodiment of the present invention may allow first to third phase change members to more efficiently absorb heat generated from a battery cell of the battery module by providing the first to third phase change members as a configuration in which a thermal interface material is added to a phase change material and may maximize the cooling rate of the battery cell by smoothly discharging the heat absorbed by the first to third phase change members to a heat sink.

Also, a battery module according to an example embodiment of the present invention is in a structure in which a cooling plate is provided between a bus bar frame and a module housing and a first phase change member is provided between a bus bar of the bus bar frame and the cooling plate and thus, the first phase change member may effectively absorb heat generated in a connecting area between a cell tab and the bus bar through the bus bar connected to the cell tab and may smoothly discharge the absorbed heat to a heat sink through the cooling plate connected to the heat sink. In particular, in the example embodiment, since the connecting area between the cell tab and the bus bar is an area in which most heat is generated in the battery module, the first phase change member may absorb and temporarily store the heat generated in the connecting area between the cell tab and the bus bar and then transfer the same to the cooling plate and accordingly, may significantly reduce the risk of fire by preventing abnormal temperature rise in the connecting area between the cell tab and the bus bar.

Also, since a battery module according to an example embodiment of the present invention is in a structure in which a first phase change member is inserted into a frame sidewall portion that protrudes in a shape that surrounds a bus bar in a bus bar frame, it is possible to easily install the first phase change member at a desired location between a cooling plate and the bus bar frame, and to prevent the first phase change member from abnormally moving from a desired installation location due to an external impact or vibration or a change in volume of the first phase change member.

Also, since a battery module according to an example embodiment of the present invention forms a phase change space portion in a sealed structure by way of a cooling plate, a bus bar, and a frame sidewall portion by forming an end of the frame sidewall portion to contact the surface of the cooling plate, it is possible to stably store a first phase change member inside the phase change space portion, to prevent the risk of displacement or loss of the first phase change member due to an external impact or vibration or a change in volume of the first phase change member, and to prevent foreign substances or moisture from penetrating into the first phase change member.

Also, since a battery module according to an example embodiment of the present invention is in a structure in which a first phase change member is provided in a connecting area between a cell tab and a bus bar, a second phase change member is provided on the top surface of a battery cell, or a third phase change member is provided between unit cells constituting the battery cell, it is possible to optimize the cooling performance of the battery module by selectively installing at least one of the first phase change member, the second phase change member, and the third phase change member depending on a design condition and situation of the battery module, and to improve the safety and productivity of the battery module by stably and effectively preventing fire and explosion of the battery module due to the temperature rise of the battery cell.

### BRIEF DESCRIPTION OF DRAWINGS

FIGS. 1 to 3 are, respectively, a side view, a front view, and a perspective view illustrating a battery module according to an example embodiment of the present invention.

FIG. 4 is an exploded perspective view of a front portion of the battery module shown in FIG. 3.

FIG. 5 is a view showing a cross section cut along line B-B shown in FIG. 2.

FIG. 6 is a view showing a cross section cut along line A-A shown in FIG. 1.

FIG. 7 is a cross-sectional view illustrating a front portion of a battery module according to another example embodiment of the present invention.

FIG. 8 is a cross-sectional view illustrating a battery module according to still another example embodiment of the present invention.

FIG. 9 illustrates modified examples for an arrangement structure of a third phase change member shown in FIG. 8.

### MODE

Hereinafter, example embodiments of the present invention are described in detail with reference to the accompanying drawings. However, the present invention is not limited to or restricted by the example embodiments. Like reference numerals illustrated in each drawing refer to like elements throughout.

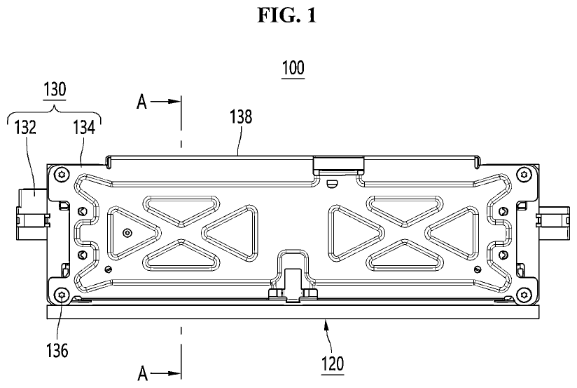

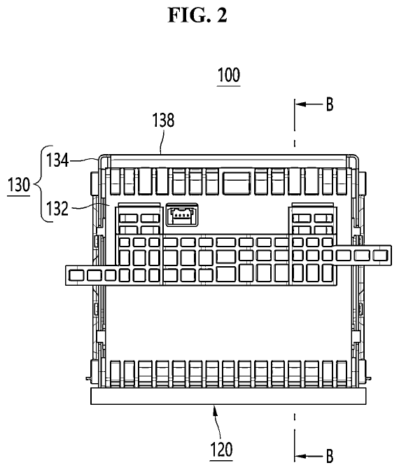

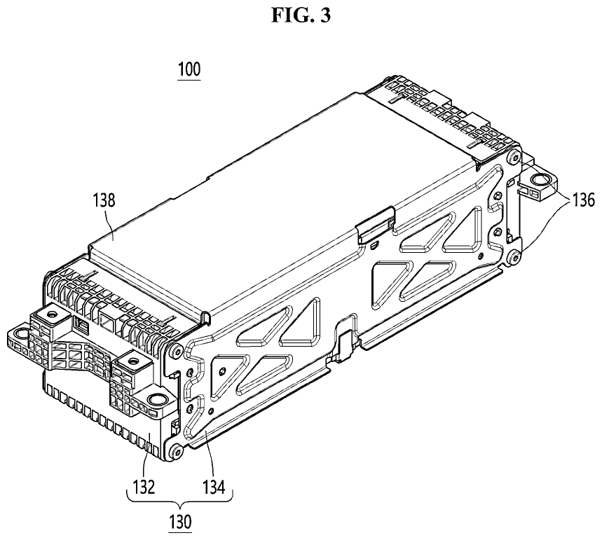

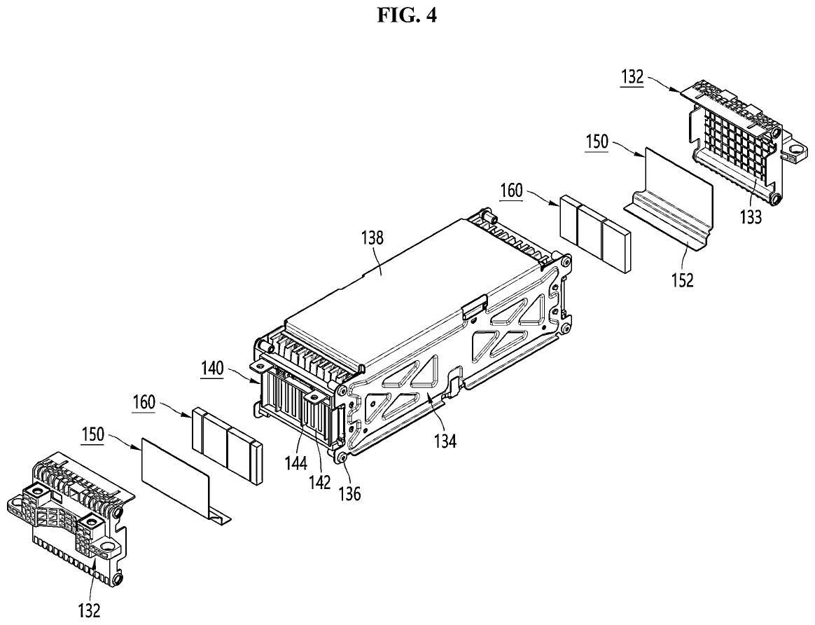

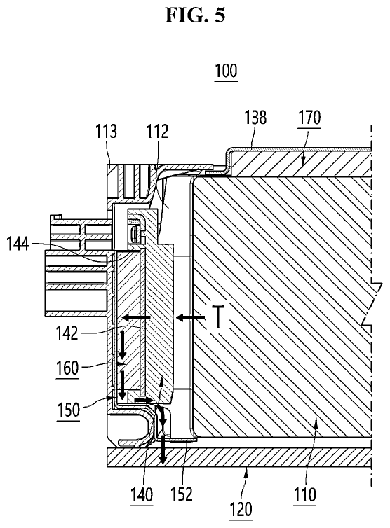

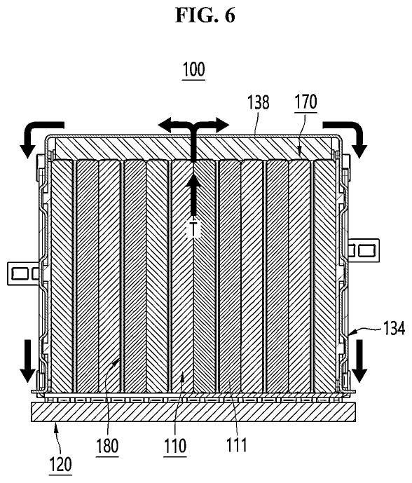

FIGS. 1 to 3 are, respectively, a side view, a front view, and a perspective view illustrating a battery module 100 according to an example embodiment of the present invention, FIG. 4 is an exploded perspective view of a front portion of the battery module 100 shown in FIG. 3, FIG. 5 is a view showing a cross section cut along line B-B shown in FIG. 2, and FIG. 6 is a view showing a cross section cut along line A-A shown in FIG. 1.

Referring to FIGS. 1 to 6, the battery module 100 according to an example embodiment of the present invention may include a battery cell 110, a heat sink 120, a module housing 130, a bus bar 142, a bus bar frame 140, a cooling plate 150, a first phase change member 160, and a second phase change member 170.

The battery module 100 of the example embodiment may be manufactured in a structure that includes the first phase change member 160 and the second phase change member 170, each including a phase change material that absorbs heat generated from the battery cell 110 while changing phase. In the following, although the example embodiment describes that the first phase change member 160 and the second phase change member 170 include the same phase change material, it is provided as an example only. Without being limited thereto, the first phase change member 160 and the second phase change member 170 may include different types of phase change materials.

Also, although the battery module 100 of the example embodiment may be used for various devices that require a battery, it is described herein that the battery module 100 is used for a battery pack of an electric vehicle for clarity of description. That is, the battery pack of the electric vehicle may include a plurality of battery modules 100, and the first phase change member 160 and the second phase change member 170 may be applied to each of the battery modules 100. However, the battery module 100 according to the example embodiment may be used for an electronic device, an electric device, a making tool, a medical device, a portable electric motor, and a laptop in which the battery module 100 may be used.

Also, the example embodiment describes that the battery cell 110 is formed in a rectangular parallepiped structure that is long in the front-to-rear direction, but may be formed in a structure of another shape, without being limited thereto. Therefore, the battery module 100 of the example embodiment may be formed in the rectangular parallepiped structure corresponding to the battery cell 110.

Meanwhile, in the example embodiment, for clarity of description of the battery module 100, the up-down direction and the left-right direction are set. In detail, it is described that the heat sink 120 is provided on the bottom of the battery module 100, the second phase change member 170 is provided on the top of the battery module 100, and the bus bar frame 140, the cooling plate 150, and the first phase change member 160 are provided at each of the front and the rear of the battery module 100.

Referring to FIGS. 4 to 6, the battery cell 110 of the example embodiment refers to a component in which charging and discharging of electricity is performed and may be accommodated inside the module housing 130. As heat is generated from the battery cell 110 in a charging and discharging process of the battery module 100, the temperature may increase.

The above battery cell 110 may be formed in a structure in which a plurality of unit cells 111 are repeatedly arranged in the left and right direction. Here, a cell tab 112 may extend long in the front and rear direction at the front and the rear of the unit cell 111. Therefore, a plurality of cell tabs 112 may be provided in a structure in which they are repeatedly arranged in the left and right direction on the front surface and the rear surface of the battery cell 110.

Meanwhile, a cushioning pad 180 may be provided between the unit cells 111 to serve as a buffer when the unit cells 111 expand. The cushioning pad 180 may be made of a polyurethane (PU)-based or silicon-based material. Hereinafter, although the present embodiment describes that two unit cells 111 are grouped into a single cell group and the cushioning pad 180 is provided between cell groups, without being limited thereto, a material and an arrangement structure of the cushioning pad 180 may be variously modified based on the design condition and situation of the battery module 100. For example, unlike the example embodiment, a single unit cell 111 or three or more unit cells 111 may be designated as a cell group and the cushioning pad 180 may be provided between the corresponding cell groups.

Referring to FIGS. 1 and 2, the heat sink 120 of the example embodiment refers to a component to discharge the heat generated from the battery cell 110 to the outside and may be provided on the bottom surface of the battery cell 110 to enable heat transfer. That is, the heat sink 120 may be provided in a shape of a square plate to cover the bottom surface of the battery cell 110, and may be in contact with the bottom surface of the battery cell 110 to absorb and discharge the heat of the battery cell 110. Between the heat sink 120 and the battery cell 110, a gap present between the heat sink 120 and the battery cell 110 may be removed using a gap filler with excellent thermal conductivity.

Referring to FIGS. 1 to 6, the module housing 130 of the example embodiment may be provided in a shape that surrounds the other outer surface of the battery cell 110 excluding the bottom surface of the battery cell 110 on which the heat sink 120 is provided. That is, the module housing 130 may be formed to cover the top surface, the left side surface, the right side surface, the front surface, and the rear surface of the battery cell 110.

For example, the module housing 130 may include a first housing cover 132 and a second housing cover 134.

The first housing cover 132 may be provided on each of the front surface and the rear surface of the battery cell 110. The first housing cover 132 may be formed in a shape corresponding to the front surface or the rear surface of the battery cell 110 to cover the front surface and the rear surface of the battery cell 110. For reference, the first housing cover 132 may be made of a plastic resin material.

Here, a plate seating portion 133 for seating the cooling plate 150 may be provided on the inner surface of the first housing cover 132 that faces the battery cell 110. The plate seating portion 133 may be formed in a groove shape for inserting the cooling plate 150 into the inner surface of the first housing cover 132.

The second housing cover 134 may be provided on the top surface, the left side surface, and the right side surface of the battery cell 110. The second housing cover 134 may be integrally provided on the top surface, the left side surface, and the right side surface of the battery cell 110. For reference, the second housing cover 134 may be made of a metal material that enables heat transfer. A lower portion of the second housing cover 134 may extend long downward to connect to the heat sink 120 to enable heat transfer.

Meanwhile, the first housing cover 132 may be fixably fastened to each of the front and the rear of the second housing cover 134 using a fastening member 136. That is, since the first housing cover 132 is stably fixed to the second housing cover 134 by the fastening member 136, the cooling plate 150 may be stably positioned at a correct location by the first housing cover 132.

Referring to FIGS. 4 and 5, the bus bar 142 of the example embodiment refers to a component that electrically connects to the cell tab 112 and may be provided to face each of the front surface and the rear surface of the battery cell 110. The bus bar 142 may be connected to the cell tab 112 of the battery cell 110 using a welding method. For reference, the bus bar 142 may be made of a metal material with excellent conductivity.

Referring to FIGS. 4 and 5, the bus bar frame 140 of the example embodiment refers to a component that supports the bus bar 142 and may be provided between the module housing 130 and the cell tab 112. In detail, the bus bar frame 140 may be provided between the cooling plate 150 seated on the first housing cover 132 and the cell tab 112 of the battery cell 110. Here, the bus bar 142 may be fixably mounted to the bus bar frame 140 and may be stably supported by the bus bar frame 140. For reference, the bus bar frame 140 may be made of a plastic resin material.

Here, in the bus bar frame 140, the bus bar 142 may be provided to penetrate the same, and a frame sidewall portion 144 may be provided to protrude in a shape that surrounds the edge of the bus bar 142. The frame sidewall portion 144 as described above may protrude from one surface of the bus bar frame 140 that faces the cooling plate 150, in a rib shape toward the cooling plate 150. Therefore, the bus bar 142 may be provided to be inserted into a groove formed by the frame sidewall portion 144.

In the bus bar frame 140, a plurality of bus bars 142 may be arranged to be separate from each other and a plurality of frame sidewall portions 144 may be provided to the bus bars 142. The bus bars 142 may be formed in the same shape, but may be formed in various shapes depending on the design condition and situation of the battery module 100. If the bus bars 142 are formed in various shapes, the bus bar frame 140 may also be formed in various shapes corresponding to the shapes of the bus bars 142.

Referring to FIGS. 4 and 5, the cooling plate 150 of the example embodiment refers to a component that absorbs the heat of the first phase change member 160 and then transfers the heat to the heat sink 120, and is in contact with the first phase change member 160 and the heat sink 120 to enable heat transfer. For reference, the cooling plate 150 may be made of a metal material.

The cooling plate 150 may be in surface contact with the first phase change member 160 inserted into the frame sidewall portion 144. The lower portion of the cooling plate 150 may be in contact with the heat sink 120 to enable heat transfer. To this end, a heat sink connecting portion 152 that is formed to extend long downward toward the heat sink 120 may be formed at the lower end of the cooling plate 150. The heat sink connecting portion 152 may be maintained in contact with the heat sink 120 when assembling the battery module 100.

Referring to FIGS. 4 and 5, the first phase change member 160 of the example embodiment refers to a component that absorbs and temporarily stores the heat generated in the connecting area between the bus bar 142 and cell tab 112 and then, transfers the heat to the cooling plate 150. The first phase change member 160 may be provided between the cooling plate 150 and the bus bar 142, and may be maintained in contact with the cooling plate 150 and the bus bar 142. That is, one of both sides of the first phase change member 160 may be in contact with the cooling plate 150 to enable heat transfer, and the other side of both sides of the first phase change member 160 may be in contact with the bus bar 142 to enable heat transfer.

The first phase change member 160 as described above serves to transfer the heat between the bus bar 142 and the cooling plate 150. Here, as the heat generated in the connecting area between the bus bar 142 and the cell tab 112 is transferred through the bus bar 142, the first phase change member 160 may absorb and temporarily store the heat. That is, the first phase change member 160 may maximize absorption and storage of the heat using latent heat required for phase change of the phase change material and may use this to smoothly respond to a high heat condition that momentarily occurs at the connecting area between the bus bar 142 and the cell tab 112.

For example, the first phase change member 160 may include a phase change material (PCM) that changes phase while absorbing the heat generated in the connecting area between the bus bar 142 and the cell tab 112, a thermal interface material (TIM) added to the phase change material for the purpose of improving the heat transfer performance, and a capsule member of an elastic material provided to accommodate the phase change material and the thermal interface material in a desired shape.

The phase change material may be formed of a material capable of changing phase while absorbing the heat of the battery cell 110 in advance at a temperature lower than the fire occurrence temperature of the battery cell 110. That is, the first phase change member 160 may absorb the heat of the battery cell 110 in advance before fire occurs in the battery cell 110, and although an abnormally large amount of heat is generated, may stably control the temperature rise of the battery cell 110 through the latent heat of the phase change process.

The capsule member may be made of a material with excellent flexibility, elasticity, and heat resistance to sufficiently cope with the volume change that occurs in the phase change process of the phase change material.

Meanwhile, the first phase change member 160 of the example embodiment may be formed in a shape corresponding to the bus bar 142, and may be provided with being inserted into the inside of the frame sidewall portion 144. A plurality of first phase change members 160 may be provided to correspond to the plurality of bus bars 142, respectively. Therefore, the first phase change member 160 may be stably supported by the frame sidewall portion 144 while being in contact with the bus bar 142, and vibration and random separation of the first phase change member 160 may be prevented. Also, since the assembly process of the battery module 100 proceeds while the first phase change member 160 is provisionally assembled to the frame sidewall portion 144, assembly-ability and work convenience of the first phase change member 160 may be improved.

Referring to FIGS. 1 to 6, the second phase change member 170 of the example embodiment refers to a component to transfer the heat generated from the battery cell 110 to the second housing cover 134, and may be provided between a top surface portion of the second housing cover 134 and the battery cell 110, and may be maintained in contact with the battery cell 110 and the second housing cover 134. That is, one of both sides of the second phase change member 170 may be in contact with the second housing cover 134 to enable heat transfer, and the other side of both sides of the second phase change member 170 may be in contact with the top surface of the battery cell 110 to enable heat transfer.

Therefore, the second phase change member 170 may absorb the heat generated from the battery cell 110 and then transfer the heat to the top surface portion of the second housing cover 134. Then, the heat transferred to the top surface portion of the second housing cover 134 may be transferred to the heat sink 120 along the left side surface and the right side surface of the second housing cover 134.

The second phase change member 170 may be formed of the same phase change material, thermal interface material, and capsule member as those of the first phase change member 160. However, depending on the design condition and situation of the battery module 100, the second phase change member 170 may be formed of a material different from that of the first phase change member 160. Hereinafter, the example embodiment describes that the first phase change member 160 and the second phase change member 170 are formed of the same material.

As described above, the second phase change member 170 is formed in a manner identical or similar to the first phase change member 160 and thus, although high-temperature heat is momentarily generated on the top surface of the battery cell 110, the phase change material of the second phase change member 170 may stably absorb and temporarily store the heat generated on the top surface of the battery cell 110 while changing phase.

Meanwhile, a phase change insertion groove 138 into which the second phase change member 170 inserts may be formed on the top surface of the second housing cover 134. The phase change insertion groove 130 may be formed in an integrated structure on the top surface of the second housing cover 134. For example, the phase change insertion groove 138 may be provided in a groove shape in which the top surface portion of the second housing cover 134 is depressed upward, and the second phase change member 170 may insert into the phase change insertion groove 138.

The operation and operation effect of the battery module 100 according to an example embodiment of the present invention constructed as above will be described as follows.

In the case of operating the battery module 100, the heat is generated from the battery cell 110 in the process of performing charging and discharging of the battery cell 110 and the temperature of the battery cell 110 increases. In particular, when the battery module 100 operates, the heat is generated in the connecting area between the cell tab 112 and the bus bar 142 and on the top surface of the battery cell 110.

As shown in FIG. 5, the heat generated in the connecting area between the cell tab 112 and the bus bar 142 is absorbed and temporarily stored by the first phase change member 160 in contact with the bus bar 142, and the heat stored in the first phase change member 160 is transferred to the cooling plate 150 and then discharged to the outside through the heat sink 120.

If the first phase change member 160 absorbs more than a preset amount of heat, a large amount of heat may be absorbed and temporarily stored as the latent heat while changing phase from solid to liquid. If an amount of heat generated in the connecting area between the cell tab 112 and the bus bar 142 decreases to a normal level or less, the heat temporarily stored during the phase change process of the first phase change member 160 may be transferred to the heat sink 120 through the cooling plate 150 and discharged to the outside through the heat sink 120.

Therefore, the connecting area between the cell tab 112 and the bus bar 142 may be an area in which the most heat is generated in the battery cell 110. However, although an amount of heat generated in the connecting area between the cell tab 112 and the bus bar 142 is large enough to cause fire in the battery module 100, the heat is absorbed as the latent heat during the phase change process of the first phase change member 160. Therefore, a rapid increase in temperature in the connecting area between the cell tab 112 and the bus bar 142 may be prevented. Since the first phase change member 160 and the cooling plate 150 effectively discharge the heat generated in the connecting area between the cell tab 112 and the bus bar 142, the cooling performance for the cell tab 112 of the battery cell 110 may be stably secured.

As shown in FIG. 6, the heat generated in an upper portion of the battery cell 110 is absorbed and temporarily stored by the second phase change member 170 in contact with the top surface of the battery cell 110, and the heat absorbed by the second phase change member 170 is transferred to the second housing cover 134 and then, discharged to the outside through the heat sink 120.

If the second phase change member 170 absorbs more than a preset amount of heat, a large amount of heat may be absorbed and stored while changing phase from solid to liquid. When the heat generated on the top surface of the battery cell 110 decreases to a normal level, the heat stored by phase change of the second phase change member 170 may be transferred to the heat sink 120 through the second housing cover 134 and then discharged to the outside through the heat sink 120.

Therefore, although an amount of heat generated in an upper portion of the battery cell 110 is large enough to cause fire in the battery module 100, the heat may be used as the latent heat consumed during the phase change process of the second phase change member 170, which may lead to preventing a rapid increase in temperature at the top of the battery cell 110. As described above, since the second phase change member 170 and the second housing cover 134 effectively discharge the heat generated from the upper portion of the battery cell 110, the cooling performance for the top surface portion of the battery cell 110 may be safely secured.

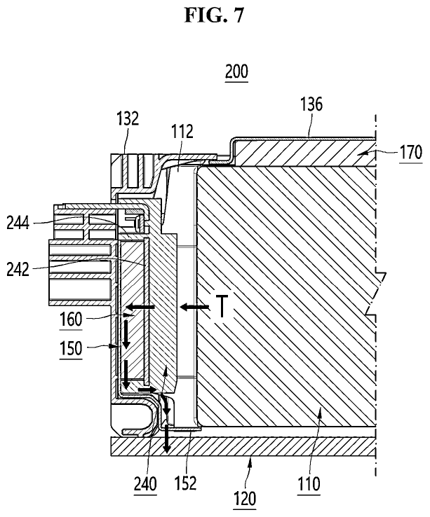

FIG. 7 is a cross-sectional view illustrating a front portion of a battery module 200 according to another example embodiment of the present invention.

In FIG. 7, reference numerals the same as or similar to those shown in FIGS. 1 to 6 refer to like elements throughout and further description related thereto is omitted. In the following, description is made based on a difference with the battery module 100 shown in FIGS. 1 to 6.

Referring to FIG. 7, a difference between the battery module 200 according to another example embodiment of the present invention and the battery module 100 shown in FIGS. 1 to 6 is that a frame sidewall portion 244 of a bus bar frame 240 is enhanced to form a sealed space for accommodating the first phase change member 160.

That is, the frame sidewall portion 244 may protrude in a rib shape from the bus bar frame 240 toward the cooling plate 150 and, here, may be formed to further protrude than a thickness of the first phase change member 160. Therefore, the frame sidewall portion 244 may closely adhere to the surface of the cooling plate 150 when assembling the battery module 200, and the first phase change member 160 may be stored inside a phase change space portion formed by the frame sidewall portion 244, the cooling plate 150, and a bus bar 242.

Here, the cooling plate 150 and the bus bar 242 are in close contact with both sides of the first phase change member 160, and the frame sidewall portion 244 is provided to surround the side circumference of the first phase change member 160. Therefore, the phase change space portion of the example embodiment may form a sealed storage space by the frame sidewall portion 244, the cooling plate 150, and the bus bar 242.

The phase change space portion stores the first phase change member 160 in a structure that shields the same from the outside and accordingly, may prevent the first phase change member 160 from leaking to the outside during phase change into liquid and may also prevent the first phase change member 160 from being displaced from its correct position due to external impact or vibration. In addition, the phase change space portion may also prevent external moisture or foreign substances from penetrating into the first phase change member 160.

As a result, the battery module 200 of the example embodiment is in a structure in which the first phase change member 160 is sealed and stored in the phase change space portion compared to the battery module 100 shown in FIGS. 1 to 6 and thus, may improve installation stability and assembly of the first phase change member 160. In particular, in the example embodiment, the first phase change member 160 is sealed and stored in the phase change space portion, so the first phase change member 160 may be formed and applied only using the phase change material and the thermal interface material without including the capsule member.

For reference, the sealing performance of the phase change space portion may be improved by sealing a gap between the frame sidewall portion 244 and the cooling plate 150 with a sealing member or by forming a groove in the cooling plate 150 into which the end of the frame sidewall portion 244 inserts.

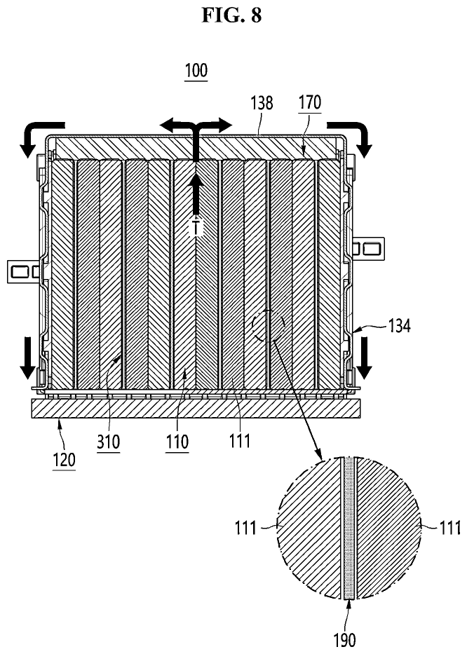

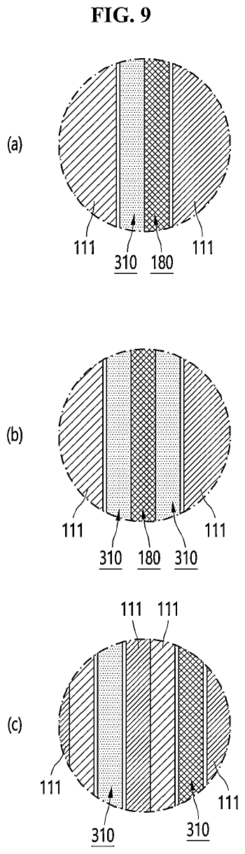

FIG. 8 is a cross-sectional view illustrating a battery module 300 according to still another example embodiment of the present invention, and FIG. 9 illustrates modified examples for an arrangement structure of a third phase change member 310 shown in FIG. 8.

In FIGS. 8 and 9, reference numerals the same as or similar to those shown in FIGS. 1 to 6 refer to like elements throughout and further description related thereto is omitted. In the following, description is made based on a difference with the battery module 100 shown in FIGS. 1 to 6.

Referring to FIGS. 8 and 9, a difference between a battery module 300 according to still another example embodiment of the present invention and the battery module 100 shown in FIGS. 1 to 6 is that the battery module 300 further includes the third phase change member 310 provided between the unit cells 111 of the battery cell 110.

That is, the battery cell 110 of the example embodiment is in a structure in which the plurality of unit cells 111 are repeatedly provided, and is in a cooling structure that directly absorbs and temporarily stores the heat generated from the side of the unit cells 111 by providing the third phase change member 310 between the unit cells 111.

As shown in FIG. 8, the battery module 300 according to an example embodiment of the present invention may further include the third phase change member 310 provided between the unit cells 111. The third phase change member 310 may absorb and temporarily store the heat generated from the unit cells 111 and then transfer the heat to the heat sink 120 connected at its lower end.

The third phase change member 310 as described above may include the phase change material that changes phase while absorbing the heat generated from the unit cells 111. That is, the third phase change member 310 may be formed of the same phase change material, thermal interface material, capsule member as those of the first phase change member 160 and the second phase change member 170. However, depending on the design condition and situation of the battery module 300, the first phase change member 160, the second phase change member 170, and the third phase change member 310 may be formed of different materials. Hereinafter, the example embodiment describes that the first phase change member 160, the second phase change member 170, and the third phase change member 310 are formed of the same material.

Therefore, the heat generated from the unit cell 111 of the battery cell 110 may be absorbed and stored by the third phase change member 310 and then, transferred to heat sink 120. The phase change material of the third phase change member 310 may absorb and temporarily store the heat generated from the unit cell 111 using the latent heat during the phase change process, and accordingly, prevent the abnormal temperature rise of the unit cell 111 by the heat generated from the unit cell 111.

Meanwhile, in the example embodiment, the unit cells 111 may be classified into a plurality of cell groups by grouping the unit cells 111 based on a preset number, and the third phase change member 310 may be provided between the respective cell groups. Hereinafter, like the battery module 100 shown in FIGS. 1 to 6, the example embodiment describes that the cell group is configured using two unit cells 111, but is not limited thereto. The cell group may be configured based on a single unit cell 111 or three or more unit cells 111.

Unlike the above, the third phase change member 310 of the example embodiment may be provided in a structure in which the phase change material is mixed with a cushioning pad that serves as a buffer when the unit cells 111 expand. For example, the third phase change member 310 of the example embodiment may be manufactured in a structure in which the phase change material and the thermal interface material are added to the cushioning pad provided in the same material and structure as the cushioning pad 180 shown in FIG. 6. Therefore, the third phase change member 310 of the example embodiment may simultaneously perform a buffering role when the unit cells 111 expand as well as a cooling role of absorbing the heat generated from the unit cells 111.

As shown in FIG. 9, FIG. 9 illustrates other modified examples for an arrangement structure of the third phase change member 310 shown in FIG. 8. That is, in FIG. 9, it is described that the third phase change member 310 including the phase change material and the cushioning pad 180 may be manufactured as separate parts, and the third phase change member 310 and the cushioning pad 180 are individually applied to the unit cells 111 of the battery cell 110. Here, the third phase change member 310 and the cushioning pad 180 may be provided using the same material and structure as those of the first phase change member 160 and the cushioning pad 180 shown in FIG. 6.

The third phase change member 310 and the cushioning pad 180 may be formed in a shape corresponding to the side of the unit cell 111 of the battery cell 110. Here, at least one third phase change member 310 and at least one cushioning pad 180 may be arranged between cell groups formed using two unit cells through various combinations depending on the design condition and situation of the battery module 300.

For example, various arrangement combinations of the third phase change member 310 and the cushioning pad 180 are illustrated in (a) of FIG. 9, (b) of FIG. 9, and (c) of FIG. 9.

(a) of FIG. 9 illustrates a modified example in which the thin film-shaped third phase change member 310 and cushioning pad 180 are laminated together and, in this state, arranged between the cell groups of the battery cell 110.

(b) of FIG. 9 illustrates another modified example in which the thin film-shaped third phase change member 310 is laminated on each of both sides of the thin film-shaped cushioning pad 180 and, in this state, arranged between the cell groups of the battery cell 110.

(c) of FIG. 9 illustrates another modified example in which the thin film-shaped third phase change member 310 and the cushioning pad 180 are alternately provided to be staggered between the cell groups of the battery cell 110.

The third phase change member 310 and the cushioning pad 180 may be provided between the cell groups of the battery cell 110 using various combinations depending on the design condition and situation of the battery module 300, optimizing the cooling performance of the battery module 300.

Meanwhile, unlike the example embodiment, the battery module may selectively variously combine the first phase change member 160, the second phase change member 170, and the third phase change member 310 depending on the design condition and situation. For example, the battery module may include only one of the first phase change member 160, the second phase change member 170, and the third phase change member 310, may include only the second phase change member 170 and the third phase change member 310 excluding the first phase change member 160, or may include only the first phase change member 160 and the third phase change member 310 excluding the second phase change member 170.

Although example embodiments of the present invention are described with specific details such as specific components and limited embodiments and drawings, it is simply provided to help the general understanding of the present invention and the present invention is not limited to the example embodiments and it will be apparent to one of ordinary skill in the art that various changes and modifications in forms and details may be made in these example embodiments from the description. Therefore, the spirit of the present invention should not be defined to the aforementioned example embodiments and equivalents of the claims or all things with equivalent modifications as well as the claims are to fall within the scope of the present invention.

1. A battery module comprising:
a battery cell formed with a cell tab;
a heat sink provided on one side of the battery cell;
a bus bar configured to connect to the cell tab;
a bus bar frame configured to support the bus bar;
a cooling plate provided separate from the bus bar frame, and connected to the heat sink to enable heat transfer; and
a phase change member provided between the cooling plate and the bus bar, and including a phase change material,
wherein a frame sidewall portion is provided to the bus bar frame to protrude in a shape that surrounds the edge of the bus bar, and
the phase change member is formed in a shape corresponding to the bus bar and provided in a state in which the phase change member is inserted into the inside of the frame sidewall portion.

2. The battery module of claim 1, further comprising:
a module housing provided to surround the outer surface of the battery cell,
wherein the cooling plate is provided inside the module housing to be seated on the inner surface of the module housing, and
a portion of the cooling plate extends long toward the heat sink and is in contact with the heat sink to enable heat transfer.

3. The battery module of claim 1, wherein the phase change member absorbs heat generated in a connecting area between the bus bar and the cell tab, and temporarily stores the same through phase change of the phase change material.

4. The battery module of claim 1, wherein
the frame sidewall portion is formed to further protrude than a thickness of the phase change member to closely adhere to the surface of the cooling plate, and
the phase change member is stored inside a phase change space portion formed by the frame sidewall portion, the bus bar, and the cooling plate.

5. A battery module comprising:
a battery cell formed with a cell tab on at least one of the front surface and the rear surface;
a heat sink provided on one side of the battery cell;
a module housing provided to surround at least a portion of the outer surface of the battery cell;
a bus bar configured to connect to the cell tab;
a bus bar frame provided between the module housing and the cell tab, and configured to support the bus bar;
a cooling plate provided between the bus bar frame and the module housing, and connected to the heat sink to enable heat transfer; and
a first phase change member provided between the cooling plate and the bus bar, and including a phase change material,
wherein a frame sidewall portion is provided to the bus bar frame to protrude in a shape that surrounds the edge of the bus bar, and
the first phase change member is formed in a shape corresponding to the bus bar and provided in a state in which the first phase change member is inserted into the inside of the frame sidewall portion.

6. The battery module of claim 5, wherein
a lower portion of the cooling plate extends long toward the heat sink and is in contact with the heat sink to enable heat transfer, and
the first phase change member absorbs heat generated in a connecting area between the bus bar and the cell tab, and temporarily stores the same through phase change of the first phase change material.

7. The battery module of claim 6, wherein the first phase change member further includes a thermal interface material added to the phase change material.

8. The battery module of claim 7, wherein the first phase change member further includes a capsule member of an elastic material provided to accommodate the phase change material and the thermal interface material.

9. The battery module of claim 5, wherein
the bus bar is provided in a plural form to the bus bar frame, and
the frame sidewall portion and the first phase change member are provided in a plural form in a shape that corresponds to each of the bus bars.

10. The battery module of claim 5, wherein
the frame sidewall portion is formed to further protrude than a thickness of the first phase change member to closely adhere to the surface of the cooling plate, and
the first phase change member is stored inside a phase change space portion formed by the frame sidewall portion, the bus bar, and the cooling plate.

11. The battery module of claim 5, wherein the module housing includes:
a first housing cover provided on each of the front surface and the rear surface of the battery cell; and
a second housing cover provided to cover the top surface, the left side surface, and the right side surface of the battery cell and of which lower end is connected to the heat sink to enable heat transfer.

12. The battery module of claim 11, further comprising:
a second phase change member provided between a top surface portion of the second housing cover and the battery cell to transfer heat generated from the battery cell to the second housing cover and that changes phase by absorbing the heat generated from the battery cell.

13. The battery module of claim 12, wherein
a phase change insertion groove into which the second phase change member inserts is formed on the top surface portion of the second housing cover, and
the heat of the second phase change member is transferred from the top surface portion of the second housing cover to the heat sink through both side portions.

14. The battery module of claim 11, wherein
a frame sidewall portion is provided to the bus bar frame to protrude in a shape that surrounds the edge of the bus bar,
the first phase change member is formed in a shape corresponding to the bus bar, and provided in a state in which the first phase change member is inserted into the inside of the frame sidewall portion, and
the first housing cover is fixably fastened to the second housing cover at a location of closely adhering the cooling plate to the first phase change member.

15. The battery module of claim 14, wherein a groove-shaped plate seating portion on which the cooling plate is seated is provided on the inner surface of the first housing cover.

16. The battery module of claim 5, wherein
the battery cell is formed in a structure in which a plurality of unit cells are repeatedly arranged, and
the cell tab is provided at each of the front and the rear of the unit cell.

17. The battery module of claim 16, further comprising:
a third phase change member provided between the unit cells to deliver heat generated from the unit cells to the heat sink, and including a phase change material that changes phase by absorbing the heat generated from the unit cells.

18. The battery module of claim 17, wherein the third phase change member is provided in a structure in which the phase change material is mixed with a cushioning pad that serves as a buffer in response to expansion of the unit cells.

19. The battery module of claim 17, wherein a cushioning pad that serves as a buffer in response to expansion of the unit cells is additionally provided between the unit cells, separate from the third phase change member.

20. The battery module of claim 19, wherein the third phase change member and the cushioning pad are formed in a shape corresponding to the unit cell, and
at least one third phase change member and at least one cushioning pad are provided between the unit cells.

21. A battery module comprising:
a battery cell including a cell tab on at least one of the front surface and the rear surface and a plurality of unit cells repeatedly arranged;
a heat sink provided on bottom side of the battery cell;
a module housing provided to surround at least a portion of the top surface and the side surface of the battery cell;
a bus bar provided between the module housing and the cell tab, and configured to connect to the cell tab;
a bus bar frame configured to support the bus bar;
a cooling plate provided between the bus bar frame and the module housing, and configured to transfer heat to the heat sink;
a first phase change member provided between the cooling plate and the bus bar;
a second phase change member provided between the battery cell and a module housing; and
a third phase change member provided between the unit cells,
wherein a frame sidewall portion is provided to the bus bar frame to protrude in a shape that surrounds the edge of the bus bar, and
the first phase change member is formed in a shape corresponding to the bus bar, and provided in a state in which the first phase change member is inserted into the inside of the frame sidewall portion.
